(19) United States
(12) Patent Application Publication
(10) Pub. No.: US 2018/0044188 A1
(43) Pub. Date: Feb. 15, 2018

(54) METHOD FOR PRODUCING ORGANICALLY MODIFIED AEROGELS

(71) Applicant: Wacker Chemie AG, Muenchen (DE)

(72) Inventors: Konrad HINDELANG, Muenchen (DE); Dominik JANTKE, Eching (DE); Richard WEIDNER, Burghausen (DE)

(21) Appl. No.: 15/552,443

(22) PCT Filed: Apr. 21, 2016
(86) PCT No.: PCT/EP2016/058835

§ 371 Date: Aug. 21, 2017

(30) Foreign Application Priority Data
Apr. 29, 2015 (DE) 102015207944.9

(51) Int. Cl. C01B 33/158; C01B 33/155; C01B 33/152

(52) U.S. Cl. CPC C01B 33/1585; C01B 33/152; C01B 33/155

(57) ABSTRACT

The invention relates to a method for producing organically modified aerogels. The problem addressed by the invention is that of providing an economical method for producing hydrophobic aerogels which can be implemented cost-effectively, simply, and safely, and which operates to save on resources. This problem is solved by the provision of a method for producing organically modified aerogels, wherein a sol containing [SiO_{4,2}] units is produced, and the sol obtained is dispersed in a continuous phase. The sol forms a separate phase and the continuous phase contains at least 20 wt % organosiloxane, a gel is formed from the sol in the continuous phase, and the gel obtained is surface-modified in the presence of a phase mediator in the continuous phase, wherein acids or chlorosilanes or mixtures thereof are added as initiator and the gels obtained are dried. The aerogels provided can be used as insulating materials, in particular in thermal insulation.

The invention relates to a method for producing organically modified aerogels by preparing a sol comprising [SiO_{4/2}] units, dispersing the resultant sol in a continuous phase where the sol forms a separate phase and the continuous phase comprises not less than 20 wt % of organosiloxane, forming a gel from the sol in the continuous phase, surface modifying the resultant gel in the presence of a compatibilizer in the continuous phase where acids or chlorosilanes or mixtures thereof are admixed as initiator, and drying the gels obtained.

Aerogels are highly porous rigid solids in that their volume is up to more than 95% pores. Whereas a lyogel represents a liquid-filled structure, the pores of an aerogel are air filled. In a hydrogel, which represents a special instance of lyogel, the pore liquid is not less than 50% water. Owing to their porous structure, aerogels have a high specific surface area, low pore diameters and a particularly low density. These properties make aerogels ideal materials for applications in thermal insulation.

While there are various species of aerogels, those based on silicate are the most widely used, being of particular technical relevance because of their low flammability.

Aerogels comprise an arborization of particle chains having very many interspaces in the form of open cells. These chains have contact points, ultimately resulting in the picture of a stable, spongelike network.

The process of preparing an aerogel is in principle very simple. A first step comprises preparing a corresponding lyogel and a second step comprises drying, i.e., exchanging the solvent for air.

The drying step, i.e., the step of removing the pore liquid, is that step of the process which is determinative for the quality of aerogels. Destruction of the gel structure has to be avoided in the course of this step. There are in essence two strategies for this:

1) “Supercritical drying”, i.e., pressure and temperature conditions above the critical point, can be used to ensure that the gel retains its structure and does not shrink or collapse. Capillary forces and hence destruction of the network are substantially avoided in the supercritical domain. The disadvantage of this method is that some technically burdensome, costly high-pressure technology is required for this process and therefore the process is difficult to realize on a large industrial scale, especially as a continuous process.

2) The same result is attainable by drying at atmospheric pressure provided the pore surface was passivated beforehand by modification (silylation). Hence silylation of the free silanol groups in the gel is a way to substantially avoid the gel structure shrinking irreversibly during drying. Since said modification usually utilizes hydrolysis-sensitive chemicals such as trimethylchlorosilane and hexamethyldisilazane, a solvent exchange is generally carried out first. Solvent exchange involves two or more steps wherein the water-containing pore liquid is replaced by inert organic solvents such as hexane in order to avoid the hydrophobing agent (trimethylchlorosilane for example) reacting with the water of the pore liquid.

In addition to stabilizing the structure in the drying step, surface modification leads to a hydrophobicization of the outside and inside surfaces of aerogels. There are many applications where an adequate hydrophobicity is absolutely essential. Especially the field of building insulation requires insulants to be permanently water-repellent, which is why hydrophobic materials are preferred for such applications.

The high specific surface area of aerogels augurs the use as carrier material and transfer agent in chemistry, for catalysis say, or in medicine. Aerogels are by virtue of their specific surface area further also useful as absorbent or filter materials.

The most striking characteristic of aerogels includes their extraordinarily low thermal conductivity. This high insulating effect is made possible by the special construction of aerogels, especially their extraordinary porous structure (densities below 0.2 g/cm³, mesopore volumes above 3 cm³/g and pore diameters below 25 nm).

Thermal insulation is an important aspect if energy consumption is to be reduced. Especially the field of building insulation is where conventional, inexpensive insulating materials such as polystyrene, polyurethane and glasswool are increasingly coming up against the limits dictated by their high flammability and/or limited insulating effect.

For the use of aerogels to be competitive, an inexpensive method of production is vital. It is accordingly advantageous to minimize the number of processing steps which have to be carried out and, in particular, to preferentially eschew time-consuming operations such as a multi-step solvent exchange.

EP 0 948 395 B1 accordingly disclosed the development of a method for producing organically modified aerogels wherein a hydrogel is surface modified directly, without first exchanging the aqueous pore liquid for organic solvents. The examples utilize a sodium water glass solution or silicon tetrachloride as SiO₂ source and hexamethyldisiloxane (HMDSO, (CH₃)₃Si—O—Si(CH₃)₃), trimethylchlorosilane (TMCS, (CH₃)₃SiCl) or trimethylsilanol ((CH₃)₃SiOH) for modification. The free OH groups of the hydrogel react therein with the silylating agents to form oxygen-bound trimethylsilyl groups (TMS, (CH₃)₃SiO_{1/2}). When the silylation is carried out by reacting some of the water in the pores of the hydrogel with the silylation medium used (e.g., TMCS) to form the water-insoluble hexamethyldisiloxane, the volume of the compound formed will necessarily displace at least some of the water out of the pores. This, during the silylation of the inside surface of the network, leads to a concurrent, complete or partial exchange of liquid in the pores of the hydrogel for the water-insoluble medium. The method disclosed has the disadvantage that the surface modification (silylation) either takes place at high temperatures of 80-100° C. or requires a very long reaction period of several days. Only the use here of large amounts of HCl and/or trimethylchlorosilane will ensure a rapid and complete form of surface modification. During the hydrophobing step, the pore liquid is displaced out of the gel and replaced by HMDSO, in which connection the authors of this patent, F. Schwertfeger and D. Frank, in a subsequent publication with M. Schmidt in the Journal of non-Crystalline Solids (vol. 225, pp. 24-29, 1998), specificize that a complete exchange of the pore liquid requires not less than 15 mol % of TMCS based on the pore water, corresponding to 81.5 g of TMCS per 100 g of hydrogel (see sample 2 in table 1), to obtain a complete exchange of the pore liquid and hence aerogels of low density (below 140 kg/m³). And 80 ml of HMDSO are by-produced per 100 g of hydrogel. So a disposal issue is created in addition to costs being incurred for the raw material. The aqueous HCl partly contaminated with salts is generally unrecyclable, but has to be disposed of via the wastewater. The high excess of trimethylchlorosilane generates a large amount of hexamethyldisiloxane, which needs an additional processing step to convert back into trimethylchlorosilane. Similarly, the reaction heat generated by the use of large amounts of TMCS requires an increased engineering effort on the process design side. For that reason, but also in order to minimize the amount of hazardous substances and thereby increase processing safety, the amount of hydrochloric acid and trimethylchlorosilane should be minimized.

In most of the methods described, including in EP 0 948 395 B1 for example, gels are initially produced via known methods and subsequently comminuted before solvent exchange steps and/or silylation in order to increase the outside surface area of the gel pieces and thereby hasten mass transfer processes. Silica-based gels are by no means soft or resilient, like for instance gels based on organic polymers. Silica gels therefore splinter on comminution in a relatively uncontrolled manner into variously sized fragments, which makes it difficult to establish the particle size in a controlled manner. By the very nature of the process, such fragments have edges and corners, potentially leading to increased attrition in the further processing of the aerogels. Such a processing procedure is also disadvantageous technically, since any comminution requires an additional processing step.

To endeavor to solve these technical disadvantages, new methods have already been developed to permit gel production in emulsion. In US20130189521A1, for example, sols based on water glass are emulsified in organic solvents such as hexane and the sol is converted into a gel in said organic solvent. In order that the gel particles may be dried under noncritical conditions, the pore liquid is exchanged for initially ethanol and finally hexane and surface modification is effected with silylation media. While this method does not require any comminuting steps, the multiple solvent-exchanging steps are technically burdensome and necessitate large amounts of solvent.

It was shown in EP 1047633 B1 using a so-called droplet column as an example that gel formation can also be carried out directly in a silylation medium. The focus of said patent is on the production of spherical particles of gel. A surface modification was not disclosed in the invention example. Since the composition of the gel and the composition of the silylation medium in EP 1047633 B1 corresponds to the examples in the patent EP 0 948 395 B1, high reaction temperatures and a high requirement of trimethylchlorosilane and/or hydrochloric acid to start the silylation reaction must also be the assumption in this case (cf. discussion regarding EP 0 948 395 B1).

The problem addressed by the invention is therefore that of providing an economical method for producing hydrophobed aerogels that is inexpensive, simple and safe/consistent in handling and does not waste resources.

The problem is solved by providing a method for producing organically modified aerogels by preparing a sol comprising [SiO_{4/2}] units, dispersing the resultant sol in a continuous phase where the sol forms a separate phase and the continuous phase comprises not less than 20 wt % of organosiloxane, forming a gel from the sol in the continuous phase, surface modifying the resultant gel in the presence of a compatibilizer in the continuous phase where acids or chlorosilanes or mixtures thereof are admixed as initiator, and drying the gels obtained.

As already noted in the introduction, aerogels are highly porous rigid solids where the pores are air filled. By contrast, a lyogel is a gel whose pores are solvent filled. In a hydrogel, which represents a special instance of a lyogel, the pores are predominantly filled with water as solvent.

The first step comprises preparing a sol comprising [SiO_{4/2}] units. In the present invention, a sol is a solution and/or colloidal dispersion of molecules and/or particles in at least one solvent and/or dispersion medium.

A solvent is a substance which is capable of thinning or dissolving gases, liquids or solids without chemical reactions between solute and solvent occurring in the process.

A dispersion is a heterogeneous mixture of two or more substances that scarcely dissolve in or chemically combine with each or one another, if at all. One or more of these substances (the disperse phase) is in a fine state of subdivision in some other continuous substance (dispersion medium, interchangeably=continuous phase). Disperse phases having a particle size of typically about 1 nm to 1 μm are classified according to their particle size as dissolved in a colloidally disperse manner.

The [SiO_{4/2}] units signify compounds in which a silicon atom is bonded to four oxygen atoms which in turn each have a free electron for a further bond. Units bonded via the oxygen atom and having Si—O—Si bonds may be present. The free oxygen atoms are in the simplest case bonded to hydrogen or carbon, or the compounds are in the form of salts preferably alkali metal salts.

The starting material (precursor) used for forming [SiO_{4/2}] units ([SiO_{4/2}] starting material) may be condensation-capable tetrafunctional or more highly functional silanes, alkoxysilanes, alkyl silicates, alkali metal silicates or colloidal silica particles/solutions known to a person skilled in the art.

The starting material used for [SiO_{4/2}] units preferably comprises compounds of the type Si(OR)₄, [SiO_{4/2}]_{w}[SiO_{3/2}(OR)]ₓ[SiO_{2/2}(OR)₂]_{y}[SiO_{1/2}(OR)₃]_{z} (where w, x, y, z are each a nonnegative integer), SiCl₄, water glasses or colloidal silica solutions. R is as defined above. It is particularly preferred to use tetraethyl orthosilicate (TEOS) or sodium water glass. It is also possible to use mixtures or hydrolysis products of the recited starting materials, especially their hydrolysis products with water and/or alcohols.

Water glass refers to glassy, i.e., amorphous, water-soluble sodium, potassium and lithium silicates solidified from a melt, or aqueous solutions thereof. Neutralizing the salt and hydrolysis converts the catenary Si—O—Si compounds into [SiO_{4/2}] units.

Particular preference is given to using tetraethyl orthosilicate (TEOS). The hydrolysis of TEOS in water may be catalyzed by acids or bases:

C₈H₂₀O₄Si+4H₂O→H₄SiO₄+4C₂H₅OH

where the resultant orthosilicic acid (H₄SiO₄) crosslinks further by formation of Si—O—Si bonds and loss of water until stoichiometrically silicon dioxide is formed:

H₄SiO₄→H₂SiO₃+H₂O

H₂SiO₃→SiO₂+H₂O

The hydrolysis of tetraalkoxysilanes is preferably carried out in aqueous solutions of mineral or organic acids, more preferably in aqueous hydrochloric acid solution.

[SiO_{4/2}] units count as oxidic units. An oxidic unit is to be understood in the context of this invention as meaning compounds in which a metal atom is solely bonded to oxygen atoms which in turn each have a free electron for a further bond. Being oxidic units, [SiO_{4/2}] units may be present in all hydrolysis-stable metal oxides, or mixtures thereof, known to a person skilled in the art, but it is preferable for ter- or quadrivalent units, more preferably just [SiO_{4/2}] units, to be present as oxidic units in addition to the [SiO_{4/2}] units. According to the invention, the sol comprises [SiO_{4/2}] units. The solid fraction of the sol preferably comprises not more than 50 wt %, more preferably comprises not more than 20 wt %, yet more preferably comprises not more than 5 wt % and most preferably comprises no further oxidic units.

The starting material (precursor) used for forming oxidic units may be, for example, any of the condensation-capable metal alkoxides, alkali metal salts, halide salts or further organic or inorganic precursors known to a person skilled in the art.

The [SiO_{4/2}] units aside, it is optionally also possible for [RₓSiO₍₄₋ₓ₎/2] units (where x=1, 2 or 3 or mixtures thereof and R is the same or different in each case and R is hydrogen or a substituted or unsubstituted organic moiety) to be also present.

In the [RₓSiO_{(4-x)/2}] units (where x=1, 2 or 3 or mixtures thereof), not only one, two or three oxygen atoms but additionally one, two or three moieties R are bonded directly to the silicon atom. So the [RₓSiO_{(4-x)/2}] units may all have bonded to the silicon atom either one moiety R and three oxygen atoms, i.e., x=1, or two moieties R and two oxygen atoms, i.e., x=2, or three moieties R and one oxygen atom, i.e., x=3. There may also be mixtures comprising [RSiO_{3/2}] units and/or [R₂SiO_{2/2}] units and/or [RSiO_{1/2}] units. Again O_{(4-x)/2} (e.g., O_{3/2}, O_{2/2} or O_{1/2}) represents 4−x (=3, 2 or 1) oxygen atoms which each have a free electron for a further bond. The starting material (precursor) used for forming [RₓSiO_{(4-x)/2}] units ([RₓSiO_{(4-x)/2}] starting material) may be condensation-capable bifunctional, trifunctional or more highly functional silanes, alkoxysilanes or siliconates which are known to a person skilled in the art. It is optionally also possible to use monofunctional silanes, alkoxysilanes or siliconates. R is as defined hereafter.

The solid fraction of the sol preferably comprises not more than 50 wt %, more preferably comprises not more than 20 wt %, yet more preferably comprises not more than 5 wt % and yet still more preferably comprises not more than 0.1 wt % of [RₓSiO_{(4-x)/2}] units. In a yet still even more preferred embodiment, the sol comprises no [RₓSiO_{(4-x)/2}] units.

The sol may additionally have added to it added substances such as IR opacifiers known to a person skilled in the art, to reduce the thermal conductivity. Similarly, to increase the mechanical stability, coated and/or uncoated fibers may be added. Useful fiber materials include inorganic fibers, for example glass fibers or mineral fibers, organic fibers, for example polyester fibers, aramid fibers, nylon fibers or fibers of vegetable origin, and also mixtures thereof.

The starting materials for forming [SiO_{4/2}] units and optionally for forming further oxidic units and/or [RₓSiO_{(4-x)/2}] units, and also optionally added and auxiliary substances are used according to the methods known to a person skilled in the art to prepare sols. Sol preparation is to be understood as meaning the step of mixing at least one starting material with at least one solvent/dispersant. This mixing step may also be accompanied and/or followed by a reaction of the starting compounds.

An alkoxysilane-based process is to be understood as meaning the preparation of sols from alkoxysilanes by, for example, hydrolysis with release of the corresponding alcohols. The hydrolysis is hastenable by admixture of an acid and/or temperature increase.

Sols from water glasses and/or siliconates are prepared, for example, by neutralizing the strong basic alkali metal silicates. This may be accomplished by methods known to a person skilled in the art, as described in EP 0 948 395 B for example, by neutralization with mineral acids and using acidic ion exchange resins.

The solids content of the sol, i.e., its concentration of oxidic units, i.e., its concentration of [SiO_{4/2}] units and optionally further oxidic units, is preferably between 3 and 30 wt %, more preferably between 5 and 20 wt %, yet more preferably between 8 and 15 wt %.

In a preferred embodiment, tetraethoxysilane (TEOS) or water glass or hydrolysis products thereof are used as [SiO_{4/2}] starting material. It is more preferable to use TEOS as [SiO_{4/2}] starting material. It is particularly preferable to transfer TEOS for sol preparation by stirring into water with hydrochloric acid as catalyst (Examples 1 and 3). The solvent or solvent mixture used for sol preparation comprises, in general, water or homogeneous mixtures of water and polar organic solvents, preferably alcohols. The water content here is preferably high enough for the water-containing mixture to form a separate liquid phase in the silylation medium. Sol formation is hastenable by admixture of catalysts, preferably acids. Mineral acids or organic acids are usable. The use of hydrochloric acid is particularly preferred. The hydrochloric acid here serves as catalyst for the hydrolysis of the alkoxy groups. The HCl concentration here is preferably 10-1000 ppm, preferably 30-300 ppm, more preferably 100-200 ppm. The reaction mixture may be heated to hasten the hydrolysis. This step proceeds with preference at 40 to 80° C., with particular preference at 55-65° C. for a period of preferably 0.1 to 3 hours, more preferably 0.5 to 1 hour. The result is the formation of a clear sol which may optionally also be stored for several hours to days. But preferably the sol is further reacted directly.

Comparable sols are also obtainable on the basis of water glass, especially sodium water glass as starting materials to form [SiO_{4/2}] units via methods known to a person skilled in the art (e.g., EP 0 948 395 B or Example 2), in which case it is optionally also possible to admix alkali metal methyl-siliconates such as potassium methylsiliconate or sodium methylsiliconate.

The 2nd step (ii) of the method comprises dispersing the resultant sol in a continuous phase where the sol forms a separate phase and the continuous phase comprises not less than 20 wt % of organosiloxane. The continuous phase in the invention comprises not less than 20 wt %, preferably not less than 50 wt %, more preferably not less than 90 wt %, yet more preferably not less than 95 wt % and most preferably not less than 98 wt % of organosiloxane.

In a particularly preferred embodiment, the liquid sol is transferred into the silylation medium. In this case, the continuous phase is also the silylation medium. This means that, in this preferred embodiment, shaping is effected by dispersing the sol in a continuous phase, while the continuous phase comprises not less than 20 wt % of organosiloxane. That is, the continuous phase also serves as reagent for surface modification.

A silylation medium is to be understood in the present application as meaning organosiloxanes, especially disiloxanes, and also solutions thereof in nonreactive polar solvents, while the silylation medium may optionally comprise initiators such as chlorosilanes, especially trimethylchlorosilane, acids, especially hydrochloric acid (HCl), and also scission products forming out of the organosiloxane, especially disiloxane. The solvents are preferably hydrocarbons such as pentane, hexane, heptane and toluene.

By organosiloxanes there are meant in the present application linear, cyclic or branched compounds of the type [R₃SiO_{1/2}]ₘ[R₂SiO]ₙ[RSiO_{3/2}]ₒ[SiO₂]ₚ (where m, n, o, p are each an integer≧0), where R is as defined hereafter. A linear organosiloxane has for example the general formula R₃Si—[O—SiR₂]ₙ—O—SiR₃. The rule is that an organosiloxane has at least one Si—C bond, i.e., at least one moiety has to be organic in nature.

Mixtures of various organosiloxanes, preferably liquid organosiloxanes are also usable according to the invention. The organosiloxane used is preferably a disiloxane of the formula R₃Si—O—SiR₃, where each R may be the same or different and is hydrogen or a substituted or unsubstituted organic moiety. Disiloxanes are chemical compounds having the formula R₃Si—O—SiR₃ or [R¹R²R³SiO_{1/2}]₂, where again R, R¹, R² and R³ are each as defined above and the disiloxane has at least one Si—C bond. Preference is given to using symmetrical disiloxanes, more preferably hexamethyldisiloxane. It is also possible to use mixtures of various disiloxanes, especially mixtures of hexamethyldisiloxane and divinyltetramethyldisiloxane. In the surface-modifying step, the free and accessible silanol groups of the silicative lyogel react with the silylation medium. In a preferred embodiment, Si—O—SiR₃ groups are formed out of Si—OH groups in the course of this reaction.

The moieties R may be the same or different and each independently represent hydrogen, an organic, linear, branched, cyclic, saturated or unsaturated, aromatic or heteroaromatic moiety, with or without substituents. This means that the moieties R may be substituted or unsubstituted. Preferred substituents are —CN, —NCO, —NR₂, —COOH, —COOR, -halogen, -(meth)acryloyl, -epoxy, —SH, —OH, —CONR₂, —O—R, —CO—R, —COO—R, —OCO—R, or —OCOO—R, —S—R, —NR—, N═R, —N═N—R, or —P═R. Preference is given to saturated or unsaturated moieties comprising C₁-C₄-, more preferably C₁-C₄-alkyl, vinyl, especially methyl or ethyl, specifically methyl.

The silylation media needed for the actual silylating reaction may also be generated from other substances, preferably other silylation media, for example in the manner of reactions and mechanisms known to a person skilled in the art (Journal of non-Crystalline Solids (vol. 225, pp. 24-29, 1998), EP 0 948 395 B), e.g., by scissioning the organosiloxane in an acidic medium, especially by scissioning of HMDSO in hydrochloric acid. The proportion of organosiloxane, preferably disiloxane, in the silylation medium for the purposes of the invention is not less than 20 wt %, preferably not less than 50 wt %, more preferably not less than 90 wt % and yet more preferably not less than 95 wt %. In a yet still more preferable embodiment, the proportion of organosiloxane in the mixture is not less than 98 wt %, i.e., commercially available concentrated organosiloxane, preferably disiloxane, more preferably hexamethyldisiloxane is used.

The admixture of the sol is accompanied and/or followed by a step of shaping the sol droplets and/or the resultant particles of gel by methods known to a person skilled in the art (emulsifying, dispersing, spraying for example), preferably by dispersing, more preferably by emulsifying. Dispersing is to be understood as meaning that the liquid sol is distributed, by stirring, in a continuous phase (the dispersion medium) and therein the sol droplets are converted into gel droplets.

Step ii (the dispersing step) is carried out in the optional presence of auxiliary substances which, for example, may stabilize the sol droplets or else influence the droplet size. The auxiliary substances used are preferably surface-active substances which may act, for example, as emulsifiers or defoamers. Surface-active is applied to organic compounds which by virtue of their structure locate at the interface between two phases such that they lower the interface tension (=surface tension) and thereby enable, for example, wetting. By lowering the surface tension, they further the commixing of two phases possibly up to the formation of an emulsion. Depending on their chemical composition and use, surface-active substances are designated as wetting agents, detergents (surfactants, soap) or emulsifiers.

The substances in question comprise in general one hydrophilic (“water-friendly”) group, which strongly attracts water, and one lipophilic (“fat-friendly”) hydrocarbonaceous group which attracts water molecules but weakly (and so is in fact hydrophobic). Any surfactants known to a person skilled in the art are typically usable. Preference is given to using nonionic, cationic or anionic surfactants or mixtures thereof. These auxiliary substances may be added to the sol and/or to the continuous phase.

The 3rd step (iii) of the method in the process comprises forming a gel out of the sol in the continuous phase. Gel formation is effected by methods known to a person skilled in the art such as pH increase and/or temperature increase. Gel formation here may take place before, during or after the admixture of the sol into the continuous phase. When a base is used to start gel formation, this base may be introduced into the sol and/or into the continuous phase.

In a preferred embodiment, the sol is admixed with a base, preferably ammonia, by stirring and within a short time, preferably within 10 minutes, more preferably within one minute, transferred into the organosiloxane, again by stirring (see Invention Examples 1 and 3). The gel formation period may extend from a few seconds up to several hours, depending on the pH and the temperature. It is advantageous to adjust the length of the gel formation period such that the sol is still liquid at the time of admixture to the silylation medium, so the sol is still conveyable in a simple manner and shaping is possible in a controlled manner. Advantageously, the base is only admixed directly before the step of dispersing the sol, by means of suitable mixing apparatuses known to a person skilled in the art, especially those having short residence times such as static mixers. The base may also already be included in the continuous phase (Example 2). The step of admixing a base may also be dispensed with in the case of a temperature-induced form of gel formation. It is advantageous in this case to heat the continuous phase. The step of dispersing the sol may be carried out in apparatuses known to a person skilled in the art (examples being stirred tanks and tubular reactors). The shape and size of the gel particles which form in the process is controllable via parameters such as stirrer speed, stirrer and/or reactor geometry and the ratio between the sol and the silylation medium. The ratio of continuous phase/sol (the volume of the continuous phase/the volume of the sol) is generally above 1, preferably between 1 and 10, more preferably between 1 and 4, yet more preferably between 1 and 2.

A gel formation pH established for the gel-forming step in the alkoxysilane-based process is preferably in the range from 7 to 10 and more preferably between 8.5 and 9.5. Any of the bases known to a person skilled in the art such as NH₄OH, NaOH, KOH, Al(OH)₃, silicates or siliconates are generally usable for this purpose, preference being given to the use of NH₄OH (ammonia), water glass or alkali metal methylsiliconate. Hastening of the gel formation time is also achievable via a temperature increase. The temperature at which the gel-forming step is carried out is generally between 0° C. and the boiling point of the solvents present, preferably between 40° C. and 80° C. and more preferably between 50 and 70° C.

Sols based on water glass as [SiO_{4/2}] starting material are preferably converted into a gel at a pH between 3 and 10, more preferably between 4 and 7 and at a temperature between the freezing point and the boiling point of the solvents present, preferably between 0 and 60° C., especially between 0 and 30° C., specifically between 5 and 20° C.

The gel-forming step may be followed by an aging step, which is likewise hastenable by known methods such as pH control and heating. An aging step for the purposes of the invention comprises incubating the gel at a temperature in the range from 20 to 100° C., preferably 50 to 70° C. and more preferably at 60° C. for 1 second to 48 hours, preferably 30 min to 24 hours and more preferably 30 min to 3 hours and a pH of 4-11, preferably 7-10 and more preferably 8-9. The (lyo)gel formed may have separated from it, before, during or after any aging step being carried out, a portion of the continuous phase (by filtration, decantation, centrifugation, evaporation for example) in order, for example, to increase the concentration of gel particles in the dispersion and thus, for example, increase space-time yields in the subsequent steps.

Before, during or after any aging step, the (lyo)gel formed may be washed with water, polar organic solvents or mixtures thereof in order to remove electrolytes for example. It is advantageous for the subsequent process for the pore liquid to contain sufficient water to be able to form a separate phase in the silylation medium, i.e., in the continuous phase. It is especially advantageous to dispense with any solvent exchange and/or washing step entirely in order, for example, to minimize the processing costs and time. It is therefore preferable that no solvent exchange should take place before step iv.

The 4th step (iv) of the method comprises surface modifying the resultant gel in the presence of a compatibilizer in the continuous phase where acids or chlorosilanes or mixtures thereof are admixed as initiator.

A compatibilizer as the term is understood in the present application comprehends a polar compound or mixtures of various such compounds that has a marked solubility not only in the water-rich phase but also in the organic phase and thus hastens the mass transfer between the two essentially immiscible phases.

It is part of the invention that the surface-modifying step takes place in the presence of a compatibilizer. A suitable compatibilizer comprises polar organic compounds or mixtures thereof such as
alcohols, especially of the chemical formula R—OH, where R is as defined above for moieties R (e.g., methanol, ethanol, isopropanol)
ketones, especially of the chemical formula R¹R²C═O, where R¹ and R² are the same or different and are each as defined above for moieties R (e.g., acetone (CH₃)₂C═O)
ethers, especially of the chemical formula R¹OR², where R¹ and R² are the same or different and are each as defined above for moieties R (e.g., diethyl ether, tetrahydrofuran, dimethoxyethane)
esters, especially of the chemical formula R¹COOR², where R¹ and R² are the same or different and are each as defined above for moieties R (e.g., ethyl acetate), and
surface-active substances such as surfactants. Surface-active substances are subject to the provided definition (see step ii).

The compatibilizer used more preferably comprises alcohols such as, for example, methanol, ethanol and isopropanol, while it is particularly preferable to use ethanol as compatibilizer.

The compatibilizer may be present in the sol, in the gel or in the continuous phase. Combinations are also possible. Preferably, the compatibilizer is admixed to the silylation medium and/or the gel and/or the sol before the surface-modifying step. More preferably, the compatibilizer is admixed in the step of preparing the sol or is formed therefrom. This means that compatibilizer is present in the sol immediately the sol is formed (step i). The compatibilizer may in effect be admixed to the sol before, during or after the preparation thereof. It is particularly preferable for the compatibilizer to be formed during the sol-preparing step, from the starting materials for forming the [SiO_{4/2}] units and/or the optionally admixed starting materials for forming further oxidic units and/or [RₓSiO_{(4-x)/2}] units. The compatibilizer used more preferably comprises ethanol and/or methanol formed out of the hydrolysis of the starting materials. The compatibilizer content of the pore liquid is preferably below 90 wt %, more preferably below 50 wt % and still more preferably between 5 and 30 wt %.

It is part of the invention that the continuous phase also serves as silylation medium. Optionally a portion of the continuous phase may be removed before the surface-modifying step in order to increase the concentration of gel particles in the silylation medium. It is also possible to admix further silylation medium in order to reduce the concentration of gel particles in order, for example, to better mix or convey the mixture. The amount of silylation medium used per ml of lyogel is preferably not less than 1 ml, more preferably 1-4 ml and yet more preferably 1-2 ml of silylation medium.

The preferred embodiment provides a distinct improvement for the overall process over the prior art because the reaction processes, especially that of surface modification, are hastened by virtue of the smaller size of the gel particles and the good commixing. Emulsions/dispersions are further very simple to convey, particle sizes are simple to control, and no additional comminuting step is needed for the gels. This simplifies any large-scale industrial manufacture because a continuous or semi-continuous process is made possible as a result. In a specifically preferred embodiment, the continuous phase used is a technically pure organosiloxane, preferably disiloxane, more preferably hexamethyldisiloxane. This is particularly advantageous because, as a result, no burdensome separation and workup of mixtures is required and the organosiloxane is directly reusable after the reaction.

The temperature in the surface-modifying step (step iv) is preferably between room temperature and the boiling point of the mixture, preferably between 40 and 80° C., more preferably between 50 and 70° C. and yet more preferably between 55 and 65° C.

The duration of the surface-modifying step (step iv) is preferably below 5 hours, more preferably below 2 hours and yet more preferably below 30 min.

The reaction conditions prevailing in the gel-forming step (step iii) and any subsequently performed optional aging step mean that, in general, no or but very slow surface modification takes place in the silylation medium because the organosiloxanes, especially disiloxanes, are but very slow to silylate under these conditions, if they do so at all. Organosiloxanes, preferably disiloxanes, can be precisely initiated by admixture of acids or acid donors such as chlorosilanes. The term “initiator” in this invention is thus an acid or a chlorosilane, or mixtures thereof and hastens the rate of surface modification. This enables a better form of process control. This is a significant advantage for the method of the invention over the most commonly used prior art mixture of hydrocarbons and trimethylchlorosilane. It is part of the invention for the surface-modifying step to be initiated by admixture of acids and/or chlorosilanes through the already described reactions and mechanisms known to a person skilled in the art. It is particularly preferable for the initiator to consist of hydrochloric acid or trimethylchlorosilane (TMSC) or mixtures thereof. It is especially preferable to use concentrated hydrochloric acid.

The TMCS in effect acts as silylation medium, reacts with the silanol groups on the gel surface and thereby leads to substantial hydrophobicization of the structure. In order to hasten the mass transfer and hence also the surface modification, good commixing is advantageously ensured during the surface-modifying step. It is thus particularly advantageous to carry out the surface-modifying step in dispersion.

Comparative Example 4 shows that the surface modification of subsequently comminuted pieces of gel, i.e., surface modification without dispersing, requires—when conducted by using the low temperature and low initiator quantity of the invention—a not less than 2 times longer silylation time than Invention Example 1. The low solids contents of the sol mean that, in general, very high volumes of matter have to be turned over in the manufacture of aerogels. Space-time yield minimization is therefore dispositive for the development of an economical process as well as initiator quantity minimization. To wit, hastening the surface modification by a factor of 2 can raise the throughput by 100 percent, leading to a significant reduction in processing costs.

The active silylation medium may also undergo a secondary reaction with the water of the pore liquid to form the corresponding organosiloxane, preferably disiloxane. It is accordingly advantageous to conduct the surface-modifying step in organosiloxanes, preferably disiloxanes, and/or in a very concentrated organosiloxane solution, since this serves to maintain a sufficiently high concentration of active silylation medium due to the above-described retroreaction with acid. Moreover, the avoidance of a further solvent, such as hexane, makes possible a simple and hence economical form of material recovery, since the aqueous phase and the organosiloxane, preferably disiloxane, phase need merely be separated. This can be done by the methods for separating organic and aqueous phases that are known to a person skilled in the art (e.g., settling pond, centrifuge, decanter, distillation, . . . ). A particularly preferred embodiment therefore utilizes a mixture of organosiloxane, preferably disiloxane, and initiator as silylation medium and eschews admixing a further solvent.

During hydrophobicization, the polar, water-containing pore liquid is displaced out of the gel and replaced by the organosiloxane and/or the organosiloxane-rich organic phase, preferably disiloxane, more preferably by HMDSO. Since the aqueous pore liquid is substantially immiscible with the organosiloxane-rich phase, a second, aqueous, liquid phase forms during the surface-modifying step. Since the aqueous phase preferably has a higher density than the organosiloxane-rich phase and the gel particles preferentially reside in the organic phase, the method of the invention provides a simple and resource-sparing form of a separation process. This is of particular importance for large-scale industrial practice in particular. What is more, the progress of the reaction can be tracked via the amount of displaced pore liquid.

Since polar liquids, especially water, are held in [SiO_{4/2}] gels by very strong bonds due to the high hydrophilicity and the low pore diameters of the network and the compatibility/miscibility between water and HMDSO is very low, the abovementioned method due to Schwertfeger (EP 0 948 395 B1) is reliant on high processing temperatures and/or high amounts of HCl and/or TMCS. To minimize the processing costs, it is advantageous to minimize the use of acid and/or chlorosilane. Surprisingly, the use of compatibilizers in combination with the strong commixing in the form of a dispersion of the gel particles in an organo-siloxane-rich continuous phase enables the surface modification of lyogels even at lower temperatures and using distinctly lower amounts of initiators such as HCl and TMCS within technically sensible times of a few hours.

The amount of initiator used per 100 g of gel is preferably not more than 20 g, more preferably not more than 10 g and yet more preferably not more than 5 g of initiator.

The examples show that the surface modification can be started not only with TMCS (Example 2) but also with HCl (Examples 1 and 3).

Example 1 compared with Example 2 compared with Comparative Example 3 shows that the application of a continuous phase which is not in accordance with the invention, i.e., a continuous phase comprising less than 20 wt % of organosiloxane, leads—even by using the low temperature and low initiator quantity of the invention—to the silylation reaction being—even after 19 hours—still incomplete, as is apparent from the fact that the aqueous pore liquid is not being displaced and therefore a separate aqueous phase is not being formed.

It is part of the invention that the time for the process of surface modification and solvent displacement is preferably less than 12 hours, more preferably between 15 minutes and 3 hours, yet more preferably between 15 minutes and 2 hours. The surface-modifying step is generally carried out between room temperature and the boiling point of the silylation medium and/or the pore liquid. The temperature at which the reaction is carried out is preferably between 40 and 90° C., more preferably between 50 and 80° C., yet more preferably between 50 and 70° C.

Examples 1 and 3 compared with Comparative Examples 1 and 2 show that when the low reaction temperature and low initiator quantity of the invention are employed without using compatibilizers in the manner of the invention, no water displacement and hence no surface modification takes place even after 19 and/or 24 hours.

It is advantageous to separate the gel particles from the aqueous phase and the excess silylation medium following the surface-modifying step. This is done by filtration in the examples of the invention. The separation process can be carried out via any of the solid-liquid and/or liquid-liquid separation methods known to a person skilled in the art (e.g., decanter, settling pool, centrifuges, water traps, distillation, . . . ). The gel or reaction mixture may be washed and/or extracted with solvents before, during or after the separating step. It is particularly advantageous to wash the reaction mixture with water in order to remove the electrolytes.

The next step of the method according to the invention, step (v), comprises drying the surface-modified and optionally washed gel. In the example of the invention, the gel is dried to constant weight in a vacuum drying cabinet at 0.01 bar and 80° C. In general, the drying step can take place not only in the supercritical region but also in the subcritical region. Drying preferably takes place below the critical point, preferably at temperatures of −30 to 200° C., more preferably 0 to 150° C., and also at pressures preferably of 0.001 to 20 bar, more preferably 0.01 to 5 bar, especially 0.01 to 2 bar. This drying step may be effected by radiative, convective and/or contact drying. Drying is preferably carried on until the gel has a residual solvent content of less than 0.1 wt %.

The drying step may optionally be preceded, accompanied or followed, preferably accompanied or followed, by a step of agglomerating the gels into larger particles. This may for example be effected by known methods (see for instance U.S. Pat. No. 6,481,649 B1 and U.S. Pat. No. 6,620,355 B1).

The present invention makes available a method for producing organically modified aerogels that is inexpensive, simple, safe/consistent in handling and resource sparing and thus economical. The method of the invention is particularly notable for combining the advantages of a rapid course of reaction and of using low quantities of initiator with mild conditions for the temperature. Gel preparation and surface modification in dispersion makes available a method which by virtue of a particularly efficient form of material recovery, rapid form of mass transfer and rapid reaction steps makes possible the realization of a continuous large-scale industrial process. The individual advantages were already detailed above.

Aerogels obtainable by the method of the invention are hydrophobic. The density of said aerogels is preferably in the range from 0.05 to 0.3 g/cm³, more preferably in the range from 0.08 to 0.2 g/cm³ and yet more preferably in the range of 0.09 and 0.15 g/cm³. The surface area of said aerogels, as determined via the BET method, is preferably in the range between 300 and 1000 m²/g, more preferably between 500 and 900 m²/g, especially between 600 and 800 m²/g. The aerogels obtained according to the invention are notable for a BJH pore volume of preferably not less than 2.0 cm³/g, more preferably not less than 3.0 cm³/g, yet more preferably not less than 4.0 cm³/g. The aerogels obtained according to the invention possess a low level of thermal conductivity. The latter when measured at 20° C. is preferably less than 0.02 W/mK, more preferably less than 0.015 W/mK and especially less than 0.01 W/mK.

The aerogels obtained according to the invention are used with preference for insulation applications, more preferably in thermal insulation and yet more preferably as thermal insulant.

The method for producing aerogels in the manner of the invention will now be more particularly described with reference to exemplary embodiments without being limited thereby.

### Analytical Methods:

### Determination of Bulk Density

Bulk density was determined according to DIN 53468 by pouring the aerogel powder without further compaction into a cylindrical vessel of known volume (50 cm³) and then determining the weight of the aerogel powder by weighing.

### Determination of BET Surface Area

Specific surface area was determined for the aerogels by the BET method of DIN 9277/66131 and 9277/66132.

### Determination of BJH Pore Volume and of Pore Size

Pore analysis was carried out by the method of Barett Joyner and Halenda (BJH, 1951) in accordance with DIN 66134. Desorption isotherm data were evaluated.

### Determination of Yield

To determine the yield, the gel particles were dried to constant weight and then weighed at room temperature.

### Determination of pH

pH was determined using a pH meter from Mettler Toledo Seven Multi; electrode: In Lab Science.

### EXAMPLES

Applicable to all examples:

tetraethyl orthosilicate (WACKER® TES28 from Wacker Chemie AG), water glass (Sigma-Aldrich: SiO₂ content: 26.5 wt %, Na₂O content: 10.6 wt %), hexamethyldisiloxane (WACKER® AK 0.65 SILICONOEL from Wacker Chemie AG), trimethylchlorosilane (SILAN M3 from Wacker Chemie AG).

All other laboratory chemicals were obtained from Sigma-Aldrich.

### Example 1

A round-bottom flask was initially charged with 210 ml of water and 1.0 ml of 1 M hydrochloric acid, followed by heating to 50° C. Under agitation by intensive stirring, 104 g of TEOS were admixed by stirring at 50° C. for one hour.

In a second flask, 700 ml of hexamethyldisiloxane were heated to 60° C. and intensively stirred.

The sol was intensively stirred while being admixed with 12.5 ml of 0.25 M ammonia solution and transferred within a minute into the second round-bottom flask holding the HMDSO. The reaction mixture was stirred at 60° C. for 3 hours. Then, 30 g of concentrated hydrochloric acid (corresponds to 9.1 g of hydrochloric acid per 100 g of gel) were admixed with stirring and the reaction mixture was stirred at 60° C. Every 15 minutes, the stirrer was stopped, the phase separation awaited (1 minute) and the volume of the displaced, aqueous phase (bottom phase) was marked. After 90 minutes, the displacement of the aqueous pore liquid was complete, i.e., the volume of the aqueous phase was maximal and did not change any further. The gel particles were subsequently separated off by filtration using a Büchner funnel (Whatman® Filter, 125 mm, Grade 40).

The gel particles were finally dried in a vacuum drying cabinet (10 mbar, 120° C.). The following values were determined as described in the analytical methods:

bulk density: 0.07 g/cm³

BET: 748 m²/g

BJH pore volume: 4.3 cm³/g

median pore diameter: 17 nm

### Example 2

In a glass beaker, 150 g of water and 150 g of water glass (Aldrich: SiO₂ content: 26.5 wt %, Na₂O content: 10.6 wt %) were mixed and cooled to 10° C. in an ice bath.

In a second glass beaker, 100 g of hydrochloric acid (7.5 wt %) were initially charged, cooled to 10° C. in an ice bath and stirred at 500 rpm with a magnetic stirrer.

The cooled water glass solution was gradually added via a dropping funnel to the hydrochloric acid solution with stirring. Care was taken with the rate of addition that the temperature does not exceed 10° C. The admixture was stopped at pH 3.2 and 22 g of ethanol were admixed as compatibilizer. The liquid sol was subsequently subjected to intensive stirring (KPG stirrer, 700 rpm) while being transferred into a mixture of 550 ml of hexamethyldisiloxane containing 1.0 g of the water glass solution as base and stirred at 60° C. for 3 hours. Then, the dispersion was heated to 80° C., admixed with 23 g of trimethylchlorosilane (corresponds to 10 g of TMCS per 100 g of gel) under agitation by stirring and further stirred at 70° C. Every 15 minutes, the stirrer was stopped, the phase separation awaited (1 minute) and the volume of the displaced, aqueous phase was marked. After 120 minutes, the displacement of the aqueous pore liquid was complete. The gel particles were subsequently separated off by filtration using a Büchner funnel (Whatman® Filter, 125 mm, Grade 40) and dried to constant weight under reduced pressure in a vacuum drying cabinet (10 mbar, 120° C.)

bulk density: 0.10 g/cm³

BET: 500 m²/g

BJH pore volume: 3.2 cm³/g

median pore diameter: 22 nm

### Example 3

A round-bottom flask was initially charged with 210 ml of water and 1.0 ml of 1 M hydrochloric acid, followed by heating to 50° C. Under agitation by intensive stirring, 104 g of TEOS were admixed by stirring at 50° C. for one hour.

In a second flask, 700 ml of an HMDSO solution (50 wt %) in n-hexane were heated to 60° C. and intensively stirred.

The sol was intensively stirred while being admixed with 12.5 ml of 0.25 M ammonia solution and transferred within a minute into the second round-bottom flask holding the HMDSO solution. The reaction mixture was stirred at 60° C. for 3 hours. Then, 30 g of concentrated hydrochloric acid (corresponds to 9.1 g of hydrochloric acid per 100 g of gel) were admixed with stirring and the reaction mixture was stirred at 60° C. Every 15 minutes, the stirrer was stopped, the phase separation awaited (1 minute) and the volume of the displaced, aqueous phase was marked. After 3 hours, the displacement of the aqueous pore liquid was complete.

The gel particles were subsequently separated off by filtration using a Büchner funnel (Whatman® Filter, 125 mm, Grade 40).

The gel particles were finally dried in a vacuum drying cabinet (10 mbar, 120° C.). The following values were determined as described in the analytical methods:

bulk density: 0.08 g/cm³

BET: 760 m²/g

BJH pore volume: 4.0 cm³/g

median pore diameter: 17 nm

### Comparative Example 1

A round-bottom flask was initially charged with 210 ml of water and 1.0 ml of 1 M hydrochloric acid, followed by heating to 50° C. Under agitation by intensive stirring, 104 g of TEOS were admixed by stirring at 50° C. for one hour.

In a second flask, 700 ml of hexamethyldisiloxane were heated to 60° C. and intensively stirred.

The sol was intensively stirred while being admixed with 12.5 ml of 0.25 M ammonia solution and transferred within a minute into the second round-bottom flask holding the HMDSO. The reaction mixture was stirred at 60° C. for 3 hours. The gel particles were subsequently separated off by filtration using a Buchner funnel (Whatman® Filter, 125 mm, Grade 40). To remove the ethanol, the gel pieces were incubated in hot distilled water (300 ml of water per 100 g of gel) at 60° C. five times for 24 hours at a time. The incubating water was decanted off after 12 hours in each period, to then be replaced by fresh water. The gel particles were subsequently dispersed in 700 ml of hexamethyldisiloxane, heated to 60° C. and admixed with 30 g of concentrated hydrochloric acid (corresponds to 9.1 g of hydrochloric acid per 100 g of gel) by stirring. Every 15 minutes, the stirrer was stopped, the phase separation awaited (1 minute) and the volume of the displaced, aqueous phase was marked. After 3 hours, no separate aqueous phase could be made out. The reaction mixture was stirred at 60° C. for a further 16 hours, after which a separate aqueous phase could still not be made out, i.e., no silylation had taken place.

### Comparative Example 2

Example 2 was repeated except that the admixture of the compatibilizer (ethanol) into the sol was omitted. No separate aqueous phase could be made out even after 24 hours.

### Comparative Example 3

A round-bottom flask was initially charged with 210 ml of water and 1.0 ml of 1 M hydrochloric acid, followed by heating to 50° C. Under agitation by intensive stirring, 104 g of TEOS were admixed by stirring at 50° C. for one hour.

In a second flask, 700 ml of n-hexane were heated to 60° C. and intensively stirred.

The sol was intensively stirred while being admixed with 12.5 ml of 0.25 M ammonia solution and transferred within a minute into the second round-bottom flask holding the n-hexane. The reaction mixture was stirred at 60° C. for 3 hours. Then, 30 g of concentrated hydrochloric acid (corresponds to 9.1 g of hydrochloric acid per 100 g of gel) were admixed with stirring and the reaction mixture was stirred at 60° C. Every 15 minutes, the stirrer was stopped, the phase separation awaited (1 minute) and the volume of the displaced, aqueous phase was marked. After 3 hours, no separate aqueous phase could be made out. The reaction mixture was stirred at 60° C. for a further 16 hours, after which a separate aqueous phase could still not be made out.

### Comparative Example 4

In a screw-lidded jar, an initial charge of 210 ml of water and 1.0 ml of 1 M hydrochloric acid was heated to 50° C. Under agitation by intensive stirring (magnetic stirrer 500 rpm), 104 g of TEOS were admixed and stirred in at 50° C. for one hour. This was followed by the admixture of 12.5 ml of 0.25 M ammonia solution, subsequent stirring for one minute and finally removal of the stirrer. The gel obtained was stored in a sealed vessel in a drying cabinet at 60° C. for 3 hours. Subsequently, the gel was pressed through a sieve having a mesh size of 5 mm in order to obtain pieces below 5 mm in size. The gel pieces were introduced into a screw flask together with 700 ml of hexamethyldisiloxane and heated to 60° C. Then, 30 g of concentrated hydrochloric acid (corresponding to about 9.1 g of hydrochloric acid per 100 g of gel) were admixed, the flask was shaken, and the volume of the displaced aqueous phase was noted every 15 minutes. It took 1.5 hours before a separate aqueous phase could be identified. The displacement of the pore liquid took 4 hours to complete.

1. A method for producing organically modified aerogels, said method comprising the following steps:
i. preparing a sol comprising [SiO_{4/2}] units,
ii. dispersing the sol in a continuous phase where the sol forms a separate phase and the continuous phase comprises not less than 20 wt % of organosiloxane,
iii. forming a gel from the sol in the continuous phase,
iv. surface modifying the gel in a presence of a compatibilizer in the continuous phase where acids or chlorosilanes or mixtures thereof are admixed as initiator, and
v. drying the gel obtained in step iv.

2. The method as claimed in claim 1, wherein the organosiloxane is a disiloxane of the formula R₃Si—O—SiR₃, where each R may be the same or different and is hydrogen or a substituted or unsubstituted organic moiety.

3. The method as claimed in claim 1, wherein the compatibilizer is admixed in the step of preparing the sol or is formed therefrom.

4. The method as claimed in claim 1, wherein alcohols are used as the compatibilizer.

5. The method as claimed in claim 1, wherein step iv takes place without a solvent exchange beforehand.

6. The method as claimed in claim 1, wherein the initiator consists of trimethylchlorosilane or hydrochloric acid or mixtures thereof.

7. The method as claimed in claim 2, wherein the disiloxane used is hexamethyldisiloxane.

8. The method as claimed in claim 4, wherein ethanol is used as the compatibilizer.

9. The method as claimed in claim 1, wherein not more than 20 g of the initiator are used per 100 g of gel.

10. The method as claimed in claim 1, wherein the surface-modifying step (step iv) is conducted at a temperature from 40 to 80° C.

11. The method as claimed in claim 1, wherein duration of the surface-modifying step (step iv) is below 5 hours.

12. The method as claimed in claim 1, wherein tetraethoxysilane (TEOS) or water glass or hydrolysis products thereof are used as [SiO_{4/2}] starting material.

13. The method as claimed in claim 2, wherein the compatibilizer is admixed in the step of preparing the sol or is formed therefrom.

14. The method as claimed in claim 13, wherein alcohols are used as the compatibilizer.

15. The method as claimed in claim 14, wherein step iv takes place without a solvent exchange beforehand.

16. The method as claimed in claim 15, wherein the initiator consists of trimethylchlorosilane or hydrochloric acid or mixtures thereof.

17. The method as claimed in claim 16, wherein the disiloxane used is hexamethyldisiloxane.

18. The method as claimed in claim 17, wherein ethanol is used as the compatibilizer.

19. The method as claimed in claim 18, wherein not more than 20 g of the initiator are used per 100 g of gel.

20. The method as claimed in claim 19, wherein the surface-modifying step (step iv) is conducted at a temperature from 40 to 80° C.

21. The method as claimed in claim 20, wherein a duration of the surface-modifying step (step iv) is below 5 hours.

22. The method as claimed in claim 21, wherein tetraethoxysilane (TEOS) or water glass or hydrolysis products thereof are used as [SiO_{4/2}] starting material.
